(19) United States
(12) Patent Application Publication
(10) Pub. No.: US 2008/0146433 A1
(43) Pub. Date: Jun. 19, 2008

(54) Ceramic Material Product and Method of Manufacture

(75) Inventors: John Carberry, Talbott, TN (US); George D. Forsythe, Landenberg, PA (US); Katherine T. Leighton, Media, PA (US)

Correspondence Address: PITTS AND BRITTIAN P C, P O BOX 51295, KNOXVILLE, TN, 37950-1295, US

(73) Assignee: Dynamic Defense Materials, LLC, Boothwyn, PA (US)

(21) Appl. No.: 11/612,172

(22) Filed: Dec. 18, 2006

(51) Int. Cl. C04B 35/565

(52) U.S. Cl. 501/90; 501/88

(57) ABSTRACT

A method for producing a ceramic material product. A filler material is provided. The filler material is divided into filler granules collectively having a median diameter approximately 10 microns or less. A pre-selected amount of carbon is provided. The carbon is divided into carbon dust and the carbon dust is allowed to coat the filler granules. The mixture of carbon-coated filler granules is formed into a selected shape. The formed mixture is placed in a substantial vacuum. The mixture is introduced to a pre-selected amount of fluid silicon and the mixture of carbon-coated filler granules and silicon is heated to a temperature at or above the melting point of the silicon.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention relates to ceramics. More particularly, this invention pertains to a ceramic material product suitable for use in ballistic armor, mirrors, optics, structural ceramics, and the like, and a method for manufacturing the same.

2. Description of the Related Art

Ceramic materials are used in applications such as mirrors, optics, structural ceramics, ballistics, and the like. In many mounting and structural applications, ceramic materials are desirable for use due to the high achievable purity and complex structural shapes possible with a ceramic material, as well as the relatively high stiffness and low creep of ceramic materials. In other ceramic applications, a lightweight ceramic material is desirable. For example, in recent decades, certain hard ceramic materials have been developed for certain armor applications. These ballistic ceramic materials, such as alumina, boron carbide, silicon carbide, and titanium diboride ceramics provide the advantage of being lighter in mass than steel and provide ballistic stopping power comparable to steel. Ballistic ceramics are extraordinarily hard, strong in compression, and relatively light weight, making them efficient at eroding and shattering armor-piercing threats. Thus, in applications in which having armor with the lowest possible mass is important, such as human body armor and aircraft armor, ballistic ceramic materials are useful.

A common method of manufacture of structures made of ceramic materials is to sinter components of ceramic materials to form the structure using hot isostatic pressing (“HIP”). In an HIP process, particles of ceramic material are subjected to elevated temperature and isostatic gas pressure in an autoclave. An inert gas is used to discourage chemical reaction of the ceramic material. The increased pressure and temperature causes the ceramic material to undergo a process called sintering, whereby the particles adhere to each other.

In using an HIP process to manufacture ballistic ceramic materials, pressures exceeding 2,000 psi and temperatures in the range of 2,225 to 2,240 degrees Centigrade are necessary to achieve sufficient adhesion of the ballistic ceramic particles. The necessity for achievement and maintenance of such high temperatures and pressures make HIP manufacture of ballistic ceramics a costly endeavor, thereby resulting in increased cost to the consumer of the ballistic armor.

Reaction bonding has been used as an alternative in manufacturing ballistic ceramic structures. In reaction bonding, a matrix or composite of ballistic ceramic particles are bonded with in situ formed silicon carbide. In this process, ballistic ceramic material particles are mixed with carbon and silicon. The mixture is then heated to a point in which a portion of the carbon and silicon react to form an amount of silicon carbide distributed throughout the matrix. This reaction results in a semi-continuous phase of silicon distributed throughout the matrix, with discontinuous silicon carbide phases bonding discontinuous phases of filler material.

The reaction bonding process poses several attractive advantages over HIP sintering. Less pressure and temperature are necessary to carry on the reaction bonding process as opposed to HIP sintering, thereby making reaction bonding more economical. Also, reaction bonding is accomplished using the relatively inexpensive raw materials of the ballistic ceramic materials, such as silicon and carbon.

However, despite the advantages of reaction bonding, the performance and quality of reaction sintered ballistic ceramic matrix has traditionally been deemed inferior to HIP manufactured ballistic armor. Ceramics inherently contain flaws such as micro cracks, porosity, voids, impurities, and residual stresses from processing that can serve as sites for initiation of failure by mechanisms such as intergranular flow, sliding and micro cracking within the initial or reflected stress wave states. U.S. Pat. Nos. 7,104,177; 6,995,103; and 6,862,970 each disclose the use of silicon as an agent to react with carbon and form silicon carbide as a phase that bonds a filler ceramic, either boron carbide or silicon carbide, together with approximately 10-20 percent of unreacted silicon remaining in the composite. This amount of excess silicon is deleterious to the ballistic performance of the finished ballistic material, since silicon undergoes a pressure induce phase transformation in the range of 9-16 GPa that results in densification up to 20 percent. As is set out in V. Domnich and Y. Gogotsi, Phase Transformation in Silicon Under Contact Loading, Rev. Adv. Mater. Sci. 3, 1-36 (2002), this phase transformation ultimately leads to void formation and failure sites upon impact by a ballistic projectile.

Moreover, in traditional reaction bonding, organic materials are added to the suspended ballistic ceramic particles without assuring that the organic materials would cover the surface of all suspended ballistic ceramic particle grains. As a result, the reaction bonded silicon carbide occurs in a discontinuous phase throughout the matrix, with uneven distribution of silicon carbide and relatively low surface area contact between the silicon carbide and filler particles. This lack of uniformity of silicon carbide distribution leads to imperfections within the ballistic ceramic composite, which in turn leads to decreased ballistic-stopping performance of the ballistic ceramic composite. Thus, quality control of the resulting ballistic ceramic matrix is difficult to maintain using traditional reaction bonding techniques.

For the composite matrix to be a more effective ballistic armor, more uniform bonding between the suspended ballistic ceramic particles and the in situ formed silicon carbide is important. Ceramic bodies tend to exhibit stronger and more reliable properties when they are uniformly fine grained, fully dense, and non-porous. Microstructure is known to influence dynamic properties thought to relate to penetration resistance. For example, N. K. Bourne, et al. “The Effect of Microstructural Variations upon the Dynamic Compressive and Tensile Strengths of Aluminas” Proceedings: Mathematical and Physical Sciences, Vol. 446, No. 1927 (Aug. 8, 1994), pp. 309-318, discloses that smaller grain size corresponds to a higher Hugonit Elastic Limit (HEL) in ceramic materials. In sintered ceramics, a higher glassy grain boundary phase is associated with lower spall strength, thus indicating that a ceramic with smaller grain size and reduced amount of second “bonding” phase exhibits improved dynamic properties and resistance to failure in dynamic impact conditions. Thus, suspending small particles of a relatively hard ballistic ceramic material, such as boron carbide, within a uniform and substantially continuous phase of softer yet tougher ballistic ceramic material, such as silicon carbide, would allow for a composite ballistic ceramic material capable of exhibiting significant ballistic stopping power.

In manufacturing a reaction bonded ceramic composite having a fine grained filler distribution, a problem arises in appropriating a filler material of sufficiently small grain size. Specifically, finely divided ceramic material suitable for use as filler is significantly more expensive than large grained ceramic material of equal purity. Moreover, a second problem arises in disbursing organic materials evenly throughout the fine grained filler material. In traditional processes of dividing a large grained ceramic material into a more fine grained material, the opportunity for contaminants to adhere to the surface of the filler granules is great. Similarly, in traditional processes of dividing carbon and other organic materials into material of sufficient grain size to allow for disbursement within the fine grained filler material, the opportunity for contaminants to oxidize portions of the organic material is great. Such contamination of the fine grained filler material and the organic material leads to reduced bonding between the filler material and the organic material, thereby reducing the amount of surface to surface contact between the continuous-phase in-situ formed ceramic material and the filler material. Such reduced surface to surface contact ultimately results in greater instances of weak points in the product ballistic armor.

### BRIEF SUMMARY OF THE INVENTION

A method for producing a ceramic material product is disclosed. A large grained filler material is provided, which is generally a ballistic ceramic material. The filler material is divided into a number of filler granules, with the filler granules collectively having a median diameter less than approximately 10 microns. An amount of carbon is provided. In a coating step, the carbon is divided into carbon dust and the carbon dust is allowed to coat the filler granules. In one embodiment, the grinding step and coating step are accomplished simultaneously by combining the filler material with the amount of carbon in one or more grinding apparatus.

Following the grinding and coating steps, the mixture is formed into a selected shape. In one embodiment, this forming is preceded by an optional addition of an organic binder to the mixture to aid in forming the mixture to a desired shape, and to aid in retaining the mixture within the desired shape. The formed mixture is then placed in a substantial vacuum, and the mixture is then exposed to a amount of fluid silicon. The formed mixture and fluid silicon are heated to a temperature at or exceeding 1,450 degrees Centigrade. Upon reaching a temperature at or around 1,450 degrees Centigrade, the silicon within the mixture reacts with the carbon dust substantially coating the filler particles. The silicon and carbon form a matrix of silicon carbide throughout the mixture, thereby suspending the filler granules within the silicon carbide matrix.

In one embodiment of the present invention, a amount of silicon particles is provided. After agitation of the filler granules and carbon dust sufficient to substantially cover the filler granules in carbon dust, the resultant coated filler granules are mixed with the amount of silicon particles. To accomplish proper disbursement of the silicon particles within the coated filler mixture, the silicon particles are selected to have an average diameter between 10 microns and 200 nanometers. In this embodiment, the disbursed silicon particles react with the carbon dust substantially coating the filler particles during the heating step to produce the silicon carbide matrix.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a flowchart showing the steps (including three optional steps) of the method for producing a ballistic ceramic material in accordance with one embodiment of the present invention;

FIG. 2 is a flowchart showing more detailed steps for accomplishing the grinding and coating steps of FIG. 1;

FIG. 3 is a cross-sectional view of an amount of the carbon-coated filler granules produced in the grinding and coating steps of FIG. 1 absent the optional addition of silicon particles, showing an enlarged view of a section of the carbon-coated filler granules;

FIG. 4 is a cross-sectional view of an amount of the carbon-coated filler granules produced in the grinding and coating steps of FIG. 1, showing an enlarged view of a section of the carbon-coated filler granules with the silicon particles added to the mixture;

FIG. 5 is a flowchart showing more detailed steps for accomplishing one embodiment of the forming step of FIG. 1;

FIG. 6 is a cross-sectional view of a vacuum furnace, shown during the heating step of FIG. 1.

FIG. 7 is a cross-sectional view of a vacuum furnace, shown during another embodiment of the heating step.

### DETAILED DESCRIPTION OF THE INVENTION

Accordingly, a method for producing a ceramic material is disclosed herein. The method of the present invention provides for the manufacture of a reaction bonded ballistic ceramic composite product having a relatively uniformly fine grained distribution, including a relatively uniformly distributed and finely divided ballistic filler suspended throughout a matrix of silicon carbide. The ballistic ceramic composite includes finely divided filler bonded by in situ silicon carbide covering substantially all of the surface area of the filler. In one embodiment, free metallic silicon is distributed within the matrix to fill the voids remaining within the ballistic ceramic composite following the in situ reaction of silicon to carbon.

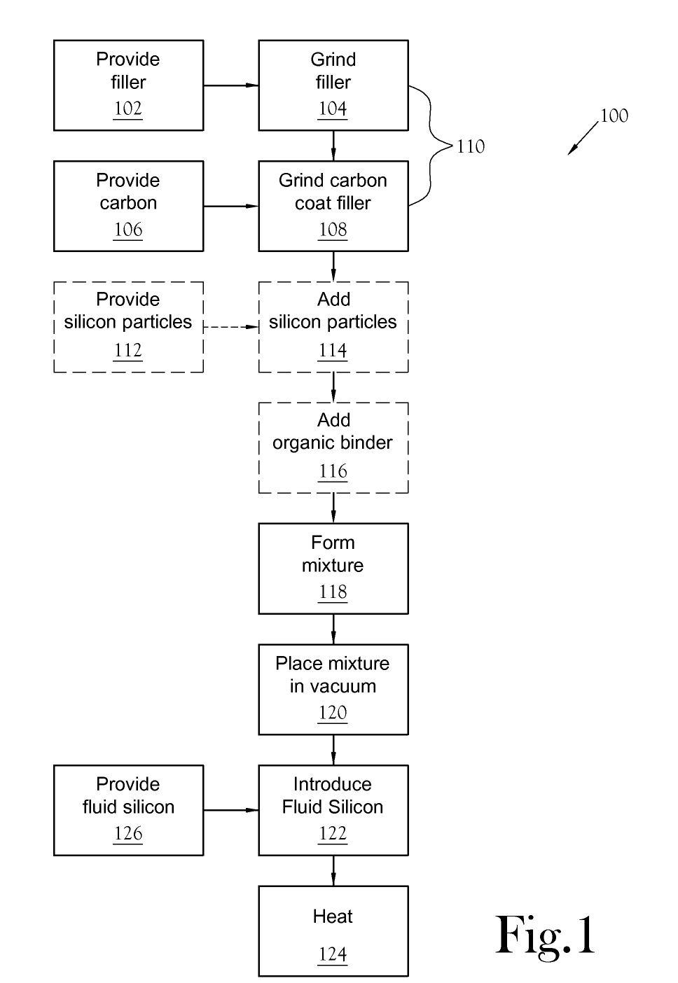

Referring now to the Figures, a process for the manufacture of ballistic ceramic material is schematically represented generally at 100 in FIG. 1. The illustrated process 100 allows for the provision 102 of a large grained filler material which is generally a ballistic ceramic material. In certain discreet embodiments, the filler material is selected from the group consisting of boron carbide and silicon carbide. However, those skilled in the art will recognize other ballistic ceramic materials suitable for use as the filler material. To this extent alumina and titanium diboride ceramics are contemplated. Furthermore, the combination of more than one type of ballistic ceramic material, such as a combination of boron carbide and silicon carbide, or other combinations, is also contemplated.

The filler material is divided at 104 into a number of filler granules, with the filler granules collectively having a median diameter less than approximately 10 microns. In several more discreet embodiments, the filler material is divided 104 such as to exhibit a plurality of modes. For example, in one embodiment, the filler granules exhibit a first mode having a median diameter of approximately 10 microns, a second mode having a median diameter of approximately 5 microns, a third mode having a median diameter of approximately 3 microns, and a fourth mode having a median diameter of approximately 1 micron. Those skilled in the art will recognize that numerous combinations of grain size exist which are suitable for the filler granules. To this extent both a bimodal grain-size distribution and a trimodal grain-size distribution are contemplated.

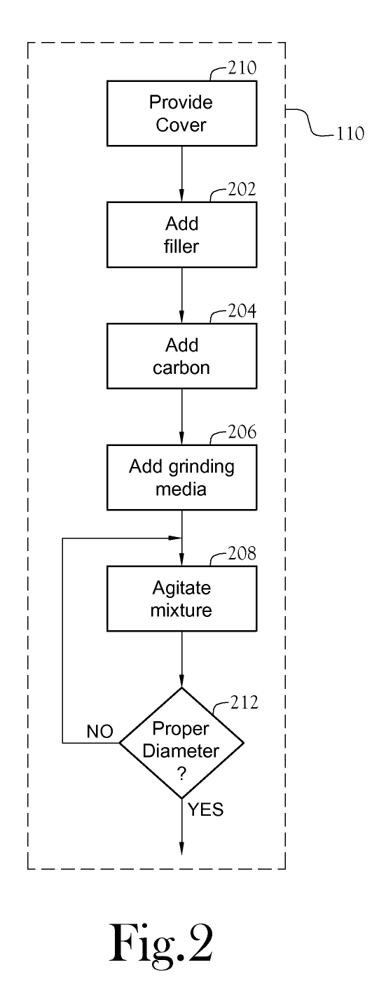

A pre-selected amount of carbon sufficient to substantially coat the filler granules is provided at 106. In an embodiment utilizing boron carbide as the filler material, an amount of carbon selected to weigh from 5-10% of the weight of the filler material is typical for filler material of particle size as described above. In a coating step 108, the carbon is divided into carbon dust and the carbon dust is allowed to coat the filler granules. FIG. 2 is a more detailed flow diagram of the process accomplished in the grinding 104 and coating 108 steps of FIG. 1. Referring to FIG. 2, the grinding step 104 and coating step 108 of FIG. 1 are accomplished simultaneously at 110, by combining the filler material at 202 with the amount of carbon 204 in one or more grinding apparatus. A suitable grinding media is provided 206 to accomplish division of the filler material and the carbon. In the illustrated embodiment, the grinding media is composed of yttria stabilized zirconia. However, steel, tungsten carbide, and other such materials are contemplated for use as the grinding media. Those skilled in the art will recognize other suitable substances to accomplish the grinding media.

In one embodiment, an attrition mill, such as those attrition mills manufactured by UNION PROCESS®, is selected to provide the grinding apparatus, due to the ability of the attrition mill to provide rapid division of the filler material with relatively high energy efficiency as compared to other grinders. However, such rapid division of the filler material is not necessary to accomplish the process of the present invention. Therefore, those skilled in the art will recognize other devices suitable for use to accomplish the grinding apparatus.

The grinding apparatus agitates the filler material, carbon, and grinding media at 208 such that the filler material is divided 104 into a number of filler granules, with the filler granules collectively having a median diameter of approximately 10 microns. At the same time, the carbon is divided into carbon dust having a sufficiently small average diameter to facilitate covering each of the filler granules with carbon dust 108. The agitation 208 of the filler material, carbon, and grinding media further serves to distribute 108 the carbon dust within the number of filler granules such that the carbon dust is allowed to substantially cover each filler granule.

By accomplishing grinding of the filler material 104 and grinding of the filler with carbon simultaneously, as illustrated in FIG. 2, the substantial covering of the filler granules by the carbon dust 108 occurs during the division of the filler material, thereby reducing the amount of outside contaminants allowed to adhere to the filler granules. To further allow for the division of the filler material and carbon absent the interference of outside contaminants, an inert cover is provided at 210 to substantially seal the filler material and carbon and to exclude atmospheric gasses from the filler material and carbon during the grinding process 110. In one embodiment, the inert cover is provided 210 by containing the grinding apparatus within an atmosphere of argon gas. In another embodiment, the inert cover is provided 210 by soaking the filler material and carbon in liquid ethanol during the grinding process. Those skilled in the art will recognize other materials suitable for use in providing the inert cover 210 without departing from the spirit and scope of the present invention.

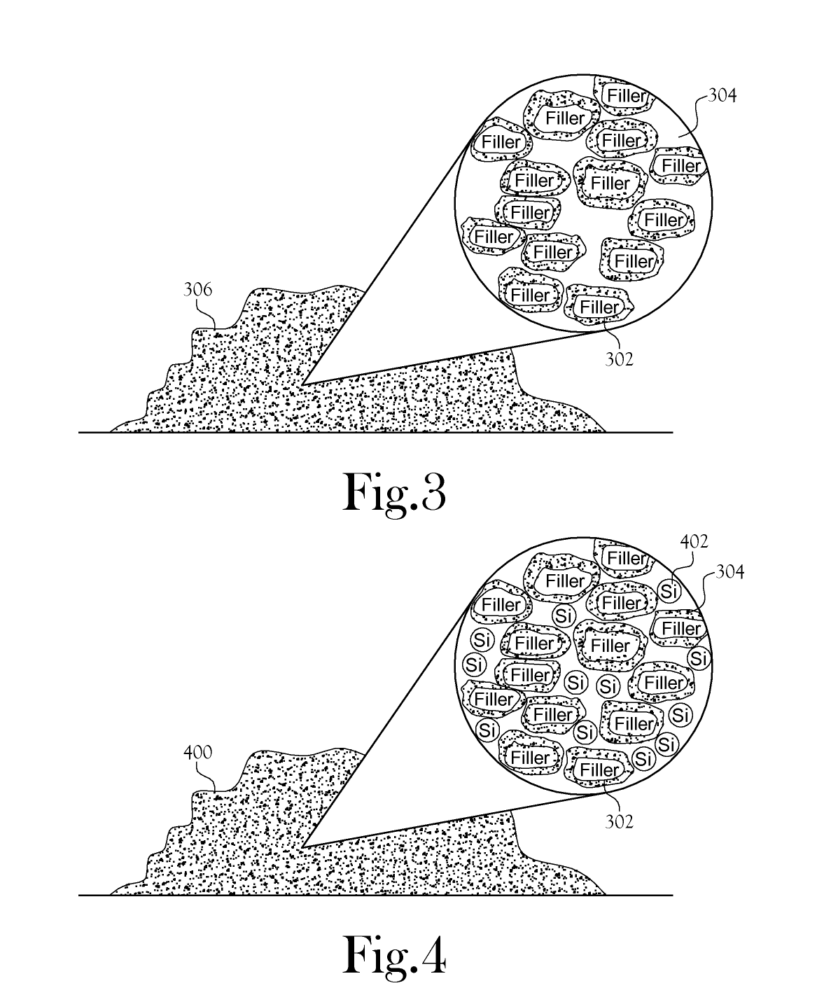

FIG. 3 is a diagram showing a mixture 306 of the filler granules 302 coated in carbon dust 304. The mixture 306 of FIG. 3 is shown absent the addition of the silicon dust 114 illustrated in FIGS. 1. It will be understood that FIG. 3 is merely a schematic diagram, and that relative diameters of the particles of the filler granules, the carbon dust, and the silicon dust are not depicted to scale. As shown in FIG. 3, the agitation 208 of the filler material and the carbon results in distribution of carbon dust 304 within the filler granules 302, with the carbon dust 304 separating the filler granules 302 from each other.

Referring again to FIG. 2, following agitation 208 of the filler material, carbon, and grinding media, an inquiry 212 is performed to determine if the filler material and carbon are within the desired range of particle diameter. If a proper diameter has been reached, further steps in the process 100 are performed. If a proper diameter has not been reached, agitation 208 of the filler material, carbon, and grinding media is continued for a selected period of time, upon which the inquiry 212 is repeated until the desired range of particle diameter is achieved.

Referring now to FIG. 1, in addition to coating 108 of the filler material with carbon, a silicon source is provided to the mixture of ground filler material coated with carbon. In an optional step of the present invention, a pre-selected amount of silicon particles is provided at 112. The amount of silicon particles is selected to be sufficient to substantially occupy the voids between the carbon-coated filler granules. Typically, the amount of silicon particles is selected to have a mass in the range of 20-40% of the mass of the filler material. In several more discreet embodiments, at least a portion of the silicon particles is optionally replaced with further additions of granular carbon.

After agitation 208 of the filler granules and carbon dust sufficient to substantially cover the filler granules in carbon dust, the resultant coated filler granules are optionally mixed at 114 with the amount of silicon particles. To accomplish proper disbursement of the silicon particles within the coated filler mixture, the silicon particles are selected to have an average diameter between 10 microns and 200 nanometers. As shown in FIG. 1, the silicon particles are added to the coated filler granules following agitation 208 and grinding of the filler granules 104 and the carbon dust 108. However, those skilled in the art will recognize that the addition of silicon particles 114 can happen at any of numerous points during or following the grinding process 110. To this extent, the addition of silicon particles 114 to the filler material and carbon mixture is contemplated to occur following the coating of the filler 108, as well as at any point during or before the agitation process 208.

FIG. 4 is diagram showing a mixture 400 of the filler granules 302 coated in carbon dust 304, and the silicon dust 402 added at 114. It will be understood that FIG. 4 is merely a schematic diagram, and that relative diameters of the particles of the filler granules 302, the carbon dust 304, and the silicon dust 402 are not depicted to scale. As shown in FIG. 4, the addition 114 of silicon 402 to the coated filler granules following agitation 208 of the filler material and the carbon results in distribution of the silicon throughout the carbon dust 304, with the carbon dust 304 separating the filler granules 302 from one another.

Referring again to FIG. 1, following the grinding 104 and coating 108 steps in the process invention 100, and following the optional addition 114 of the silicon, the mixture is formed at 118 into a selected shape. In one embodiment of the present invention, this forming 118 is preceded by an optional adding 116 of an amount of organic binder to the mixture. The organic binder is provided to aid in forming the mixture to a desired shape, and to aid in retaining the mixture within the desired shape. The organic binder further serves to provide an increased source of carbon to the mixture to increase the amount of in-situ formed silicon carbide. In one embodiment, the organic binder is an organometallic substance. However, those skilled in the art will recognize other substances suitable for use as the organic binder. Following the optional adding 116 of an organic binder, the mixture is formed 118.

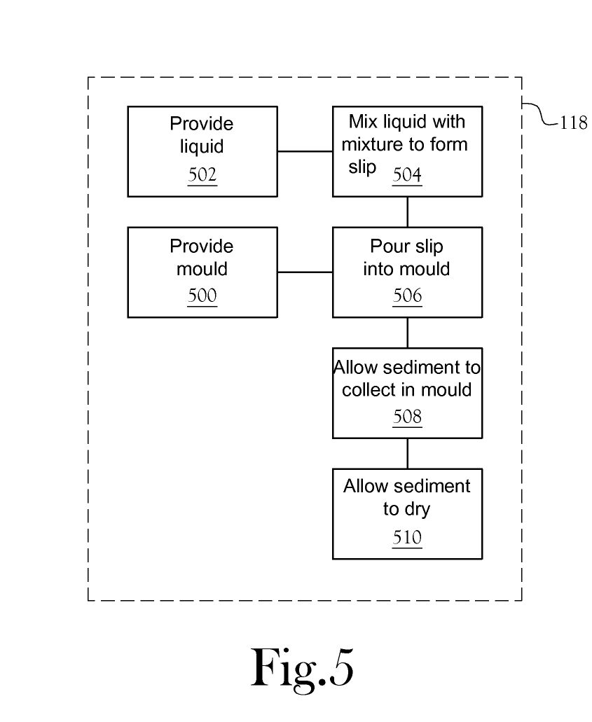

In one embodiment, the forming step 118 occurs through the process of slip casting, which is depicted in the flow diagram of FIG. 5. A mould is provided 500 which is fabricated at least partially of a material having a reduced porosity sufficient to substantially discourage the particles of the mixture from permeating the mould. A liquid is provided 502 and mixed 504 with the mixture to form a slip. The slip is then poured 506 into the mould, and the mixture is allowed to precipitate in the form of sediment within the mould 508, thereby forming a cast of the mixture within the mould. At 510, the liquid is removed from the mould 510, thus allowing the cast to substantially dry. After the liquid is removed from the mold 510, the mixture remains in a formed shape, thereby accomplishing the forming step 118.

In one embodiment of the process invention 100 in which the inert cover is provided 210 by soaking the filler material and carbon in liquid ethanol during the grinding process, such liquid ethanol is used as the slip liquid 502 during the slip casting process. Thus, in one embodiment, the provision of the inert cover 210 is combined with the provision of the slip liquid 502. Furthermore, those skilled in the art will recognize other methods, such as freeze casting, dry pressing, iso-pressing, extrusion, and other such methods suitable for use to form the mixture 118 into a desired shape. Such methods may be used to accomplish forming of the mixture 118 without departing from the spirit and scope of the present invention.

Referring again to FIG. 1, following forming 118 of the mixture, the formed mixture is placed in a substantial vacuum 120. A pre-selected amount of fluid silicon is provided at 126. The amount fluid silicon is selected to be sufficient to substantially permeate the carbon-coated filler granules and react with the carbon dust. Typically, the amount of fluid silicon is selected to have a weight in the range of 40-60% of the weight of the formed mixture. Those skilled in the art will recognize that the amount of fluid silicon may be reduced relative to the amount of silicon particulates optionally added at 112.

The mixture is then exposed to the amount of fluid silicon 122. The formed mixture and fluid silicon are heated 124 to a temperature at or exceeding the melting point of the silicon, whereby the fluid silicon substantially permeates among the particles of the mixture. Upon reaching a temperature at or around the melting point of the silicon, the silicon within the mixture, including any silicon particles optionally added at 114, reacts with the carbon dust substantially coating the filler particles. The silicon and carbon form a substantially continuous phase of silicon carbide throughout the mixture. Thus, heating of the silicon vapor and the mixture results in creation of a matrix of silicon carbide with the filler particles suspended within a substantially continuous phase of silicon carbide.

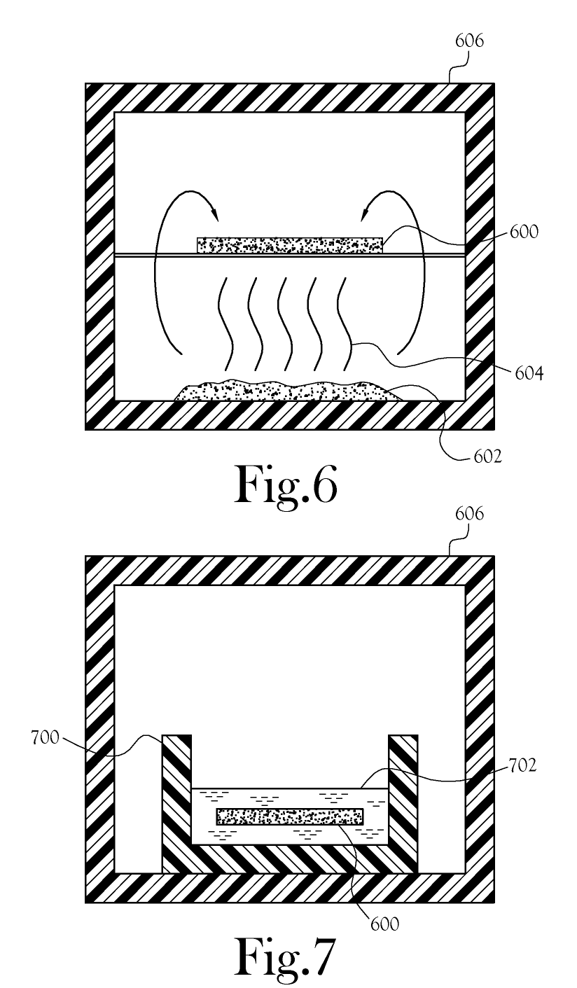

In certain embodiments, illustrated in FIGS. 6 and 7, the steps of placing the mixture in a substantial vacuum 120, introducing the silicon vapor 122, and heating 124 each occur within the confines of a vacuum furnace 606. As shown in FIG. 6, a vacuum furnace 606 is provided, suitable to contain the formed mixture 600 along with the silicon 602 provided at 112 in FIG. 1. Each of the formed mixture 600 and the silicon 602 is placed into the vacuum furnace 606. The vacuum furnace 606 is then substantially depressurized, and heated to a temperature at or exceeding the vaporization point of silicon. The vacuum furnace 606 thereby heats the silicon 602 until the silicon 602 reaches a vaporous state, the silicon vapor 604 thus substantially filling the vacuum furnace 606. In this manner, the formed mixture 600 is exposed to the silicon vapor 604, and the silicon vapor is allowed to substantially permeate among the particles of the mixture.

FIG. 7 illustrates another configuration of the vacuum furnace. In FIG. 7, a crucible 700 is provided within the vacuum furnace 606. The crucible 700 contains an amount of silicon 702. In this embodiment, the formed mixture 600 is exposed to the amount of fluid silicon 122 by placing the formed mixture 600 into the crucible 700 containing the silicon 702. The formed mixture and fluid silicon are then heated 124 within the crucible 700 by the vacuum furnace 606 to a temperature at or exceeding the melting point of the silicon, whereby the melted silicon substantially permeates between the particles of the mixture. In this manner, the steps of introducing the fluid silicon 122 and heating the formed mixture and silicon 124 are accomplished within the crucible 700.

During the heating process 124, the silicon vapor 604 permeates the grains of the formed mixture 600 to react with the carbon dust 304 to form silicon carbide. In one embodiment of the process invention 100, the provision of silicon 112 and the provision of carbon 106 occur in a substantially stoichiometrically balanced fashion, such that the silicon 112 is substantially consumed during the formation of the silicon carbide matrix. In another embodiment, sufficient silicon is provided 112 to allow silicon vapor 604 to continue to permeate and accumulate within the formed mixture 600, thereby filling at least a portion of any voids within the silicon carbide matrix with silicon.

From the foregoing description, it will be clear to one of skill in the art that a silicon carbide matrix suspending particulates of filler material is formed to produce a ceramic material. The ceramic material produced by the process invention 100 contains suspended particulates of filler material having sufficient small grain size, high surface area, and small facets, such that the ceramic material exhibits desirable strength, high weibull modulus, high thermal conductivity, high K1C and attractive thermal and wear properties for use in ballistic applications.

One skilled in the art will recognize that the ceramic material product disclosed herein is suitable for use in a number of applications, including ballistic armor, mirrors, optics, structural ceramics, and the like. For example, mirror mounts, optical elements, and other such structures composed at least in part from the ceramic material of the process invention 100 would benefit from the relatively high stiffness, low creep, and low coefficient of thermal expansion of the ceramic material. Semiconductor fixtures and furniture composed at least in part from the ceramic material of the process invention 100 would benefit from the high achievable purity, low coefficient of thermal expansion, low creep, and the complex structural shapes possible with the ceramic material of the process invention 100.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A method for manufacturing a ceramic body comprising the steps of:
(a) providing a filler material;
(b) providing a pre-selected amount of carbon;
(c) grinding said filler material into filler granules collectively having a median diameter of approximately 10 microns or less;
(d) substantially coating said filler granules with said carbon;
(e) forming said mixture of carbon-coated filler granules into a selected shape;
(f) placing said formed mixture in a substantial vacuum;
(g) providing a pre-selected amount of fluid silicon;
(h) introducing said pre-selected amount of fluid silicon to said formed mixture; and
(i) heating said mixture of carbon-coated filler granules to a temperature at or above the melting point of said silicon, such as to cause at least a portion of said fluid silicon to permeate at least a portion of said carbon to react with said carbon to form silicon carbide, thereby creating a matrix of suspended filler granules within said silicon carbide.

2. The method of claim 1, wherein said filler material is a ballistic ceramic material.

3. The method of claim 1, wherein said filler material is selected from the group consisting essentially of boron carbide and silicon carbide.

4. The method of claim 1, said grinding of said filler material of step (c) being performed in an attrition mill.

5. The method of claim 1, said steps (c) and (d) being accomplished through the following steps:
(I) placing said filler material into a grinding apparatus;
(II) placing said carbon into said grinding apparatus;
(III) providing a pre-selected amount of grinding media within said grinding apparatus; and
(IV) agitating said grinding media, said filler material, and said carbon within said grinding apparatus to form filler granules collectively having an median diameter of approximately 10 microns or less, to grind said carbon into fine carbon particles, and to substantially coat said filler granules being in fine carbon particles.

6. The method of claim 1 further comprising the steps of:
(d-I) providing a pre-selected amount of silicon particles; and
(d-II) substantially disbursing said pre-selected amount of silicon particles throughout said mixture of carbon-coated filler granules.

7. The method of claim 1 further comprising the step of adding an organic binder to said mixture of carbon-coated filler granules prior to forming, whereby said organic binder aids in step (e) of forming said mixture of carbon-coated filler granules into a selected shape.

8. The method of claim 1, said step (e) of forming said mixture of carbon-coated filler granules into a selected shape being accomplished through freeze casting said carbon-coated filler granules into said selected shape.

9. The method of claim 1, said step (e) of forming said mixture of carbon-coated filler granules into a selected shape being accomplished through the following steps:
(I) providing a mould defining said selected shape;
(II) providing a liquid, said carbon and said filler material being substantially insoluble in said liquid;
(III) mixing said liquid with said mixture of carbon-coated filler granules to form a slip; and
(IV) slip casting said slip to form said mixture of carbon-coated filler granules into said selected shape.

10. The method of claim 1, wherein step (i) includes heating said mixture of carbon-coated filler granules and silicon metal granules to a temperature at or above the melting point of said silicon.

11. The method of claim 1, wherein said fluid silicon is in a substantially vaporous form.

12. The method of claim 1, wherein said pre-selected amount of fluid silicon is substantially stoichiometrically balanced with said carbon so as to cause substantially complete reaction of said fluid silicon with said carbon.

13. A method for manufacturing a ceramic body comprising the steps of:
(a) providing a filler material;
(b) providing a pre-selected amount of carbon;
(c) providing a pre-selected amount of silicon granules, said silicon granules having an average diameter between 10 microns and 200 nanometers;
(d) providing a pre-selected amount of fluid silicon;
(e) grinding said filler material into filler granules collectively having a median diameter of approximately 10 microns or less;
(f) substantially coating said filler granules with carbon;
(g) mixing said carbon-coated filler granules with said silicon granules;
(h) forming said mixture of carbon-coated filler granules into a selected shape;
(i) placing said mixture of carbon-coated filler granules and silicon granules in a substantial vacuum;
(l) introducing said pre-selected amount of fluid silicon to said mixture of carbon-coated filler granules and silicon metal granules; and
(k) heating said mixture of carbon-coated filler granules and silicon granules to a temperature at or above the melting point of said silicon granules, such as to cause at least a portion of said carbon to react with said fluid silicon and silicon granules to form silicon carbide, thereby creating a matrix of suspended filler granules within said silicon carbide.

14. The method of claim 13, wherein said filler material is a ballistic ceramic material.

15. The method of claim 13, wherein said filler material is selected from the group consisting essentially of boron carbide and silicon carbide.

16. The method of claim 13, said grinding of said filler material of step (e) being performed in an attrition mill.

17. The method of claim 13, said steps (d) and (e) being accomplished through the following steps:
(I) placing said filler material into a grinding apparatus;
(II) placing said carbon into said grinding apparatus;
(III) providing a pre-selected amount of grinding media within said grinding apparatus; and
(IV) agitating said grinding media, said filler material, and said carbon within said grinding apparatus to form filler granules collectively having an median diameter of approximately 10 microns or less, to grind said carbon into fine carbon particles, and to substantially coat said filler granules being in fine carbon particles.

18. The method of claim 13 further comprising the step of mixing at least a portion of said silicon particles with said carbon, wherein step (b) includes substantially coating said filler granules with said mixture of ground silicon and carbon.

19. The method of claim 13 further comprising the step of adding an organic binder to said mixture of carbon-coated filler granules prior to forming, whereby said organic binder aids in step (g) of forming said mixture of carbon-coated filler granules into a selected shape.

20. The method of claim 13, said step (h) of forming said mixture of carbon-coated filler granules into a selected shape being accomplished through freeze casting said carbon-coated filler granules into said selected shape.

21. The method of claim 13, said step (h) of forming said mixture of carbon-coated filler granules into a selected shape being accomplished through the following steps:
(I) providing a mould defining said selected shape;
(II) providing a liquid, said carbon and said filler material being substantially insoluble in said liquid;
(III) mixing said liquid with said mixture of carbon-coated filler granules to form a slip; and
(IV) slip casting said slip to form said mixture of carbon-coated filler granules into said selected shape.

22. The method of claim 13, wherein step (j) includes heating said mixture of carbon-coated filler granules and silicon metal granules to a temperature at or above approximately 1,460 degrees Centigrade.

23. The method of claim 13, wherein said fluid silicon is in a substantially vaporous form.

24. The method of claim 13, wherein said pre-selected amount of fluid silicon is substantially stoichiometrically balanced with said pre-selected amount of silicon particles and said pre-selected amount of carbon so as to cause substantially complete reaction of said fluid silicon and said silicon particles with said carbon.

25. A method for manufacturing a ceramic body comprising the steps of:
(a) placing a pre-selected amount of filler material into a grinding apparatus;
(b) placing a pre-selected amount of carbon into said grinding apparatus;
(c) grinding said filler material and said carbon to form filler granules substantially coated in fine carbon particles, said filler granules collectively having an median diameter of approximately 10 microns or less;
(d) mixing said carbon-coated filler granules with a pre-selected amount of silicon granules, said silicon granules having an average diameter between 10 microns and 200 nanometers;
(e) forming said mixture of carbon-coated filler granules into a selected shape;
(f) placing said formed mixture in a substantial vacuum; and
(g) heating said mixture of carbon-coated filler granules and silicon granules to a temperature at or above the melting point of said silicon granules such as to cause at least a portion of said carbon to react with said silicon granules to form silicon carbide, thereby creating a matrix of suspended filler granules within said silicon carbide.

26. The method of claim 25, wherein said filler material is a ballistic ceramic material.

27. The method of claim 25, wherein said filler material is selected from the group consisting essentially of boron carbide and silicon carbide.

28. The method of claim 25, said grinding of said filler material of step (c) being performed in an attrition mill.

29. The method of claim 25, said steps (c) and (d) being accomplished through the following steps:
(I) placing said filler material into a grinding apparatus;
(II) placing said carbon into said grinding apparatus;
(III) providing a pre-selected amount of grinding media within said grinding apparatus; and
(IV) agitating said grinding media, said filler material, and said carbon within said grinding apparatus to form filler granules collectively having an median diameter of approximately 10 microns or less, to grind said carbon into fine carbon particles, and to substantially coat said filler granules being in fine carbon particles.

30. The method of claim 25 further comprising the step of adding an organic binder to said mixture of carbon-coated filler granules prior to forming, whereby said organic binder aids in step (e) of forming said mixture of carbon-coated filler granules into a selected shape.

31. The method of claim 25, said step (e) of forming said mixture of carbon-coated filler granules into a selected shape being accomplished through freeze casting said carbon-coated filler granules into said selected shape.

32. The method of claim 25, said step (e) of forming said mixture of carbon-coated filler granules into a selected shape being accomplished through the following steps:
(I) providing a mould defining said selected shape;
(II) providing a liquid, said carbon and said filler material being substantially insoluble in said liquid;
(III) mixing said liquid with said mixture of carbon-coated filler granules to form a slip; and
(IV) slip casting said slip to form said mixture of carbon-coated filler granules into said selected shape.

33. The method of claim 25, wherein step (i) includes heating said mixture of carbon-coated filler granules and silicon metal granules to a temperature at or above approximately 1,460 degrees Centigrade.

34. The method of claim 25, wherein said fluid silicon is in a substantially vaporous form.

35. The method of claim 25, wherein said pre-selected amount of fluid silicon is substantially stoichiometrically balanced with said carbon so as to cause substantially complete reaction of said fluid silicon with said carbon.

36. A ceramic body manufactured by a process comprising the steps of:
(a) providing a filler material;
(b) providing a pre-selected amount of carbon;
(c) grinding said filler material into filler granules collectively having a median diameter of approximately 10 microns or less;
(d) substantially coating said filler granules with said carbon;
(e) forming said mixture of carbon-coated filler granules into a selected shape;
(f) placing said formed mixture in a substantial vacuum;
(g) providing a pre-selected amount of fluid silicon;
(h) introducing said pre-selected amount of fluid silicon to said formed mixture; and
(i) heating said mixture of carbon-coated filler granules to a temperature at or above the melting point of said silicon, such as to cause at least a portion of said fluid silicon to permeate at least a portion of said carbon to react with said carbon to form silicon carbide, thereby creating a matrix of suspended filler granules within said silicon carbide.

37. The ceramic body of claim 36, wherein said filler material is a ballistic ceramic material.

38. The ceramic body of claim 36, wherein said filler material is selected from the group consisting essentially of boron carbide and silicon carbide.

39. The ceramic body of claim 36, said grinding of said filler material of step (c) being performed in an attrition mill.

40. The ceramic body of claim 36, said process steps (c) and (d) being accomplished through the following steps:
(I) placing said filler material into a grinding apparatus;
(II) placing said carbon into said grinding apparatus;
(III) providing a pre-selected amount of grinding media within said grinding apparatus; and
(IV) agitating said grinding media, said filler material, and said carbon within said grinding apparatus to form filler granules collectively having an median diameter of approximately 10 microns or less, to grind said carbon into fine carbon particles, and to substantially coat said filler granules being in fine carbon particles.

41. The ceramic body of claim 36, said process further comprising the steps of:
(d-I) providing a pre-selected amount of silicon particles; and
(d-II) substantially disbursing said pre-selected amount of silicon particles throughout said mixture of carbon-coated filler granules.

42. The ceramic body of claim 36, said process further comprising the step of adding an organic binder to said mixture of carbon-coated filler granules prior to forming, whereby said organic binder aids in step (e) of forming said mixture of carbon-coated filler granules into a selected shape.

43. The ceramic body of claim 36, said process step (e) of forming said mixture of carbon-coated filler granules into a selected shape being accomplished through freeze casting said carbon-coated filler granules into said selected shape.

44. The ceramic body of claim 36, said process step (e) of forming said mixture of carbon-coated filler granules into a selected shape being accomplished through the following steps:
(I) providing a mould defining said selected shape;
(II) providing a liquid, said carbon and said filler material being substantially insoluble in said liquid;
(III) mixing said liquid with said mixture of carbon-coated filler granules to form a slip; and
(IV) slip casting said slip to form said mixture of carbon-coated filler granules into said selected shape.

45. The ceramic body of claim 36, wherein process step (i) includes heating said mixture of carbon-coated filler granules and silicon metal granules to a temperature at or above the melting point of said silicon.

46. The ceramic body of claim 36, wherein said fluid silicon is in a substantially vaporous form.

47. The ceramic body of claim 36, wherein said pre-selected amount of fluid silicon is substantially stoichiometrically balanced with said carbon so as to cause substantially complete reaction of said fluid silicon with said carbon.
